(19) United States
(12) Patent Application Publication
(10) Pub. No.: US 2025/0306842 A1
(43) Pub. Date: Oct. 2, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: TAKANORI KATSUMATA, Kanagawa (JP); NAOHITO NAKAMURA, Kanagawa (JP)

(21) Appl. No.: 19/079,286

(22) Filed: Mar. 13, 2025

(30) Foreign Application Priority Data
Mar. 29, 2024 (JP) 2024-055833
Dec. 18, 2024 (JP) 2024-223121

(51) Int. Cl. G06F 3/14; G06T 11/00

(52) U.S. Cl. CPC G06F 3/1454; G06T 11/001; G06T 2210/62

(57) ABSTRACT

An information processing apparatus for controlling a display operation of a display device which a user wears includes an acquisition unit configured to acquire virtual object information which is information about a virtual object which the information processing apparatus causes the display device to display, and a control unit configured to control displaying of an image of the virtual object based on the virtual object information acquired by the acquisition unit, wherein, in a case where a masking flag which indicates superimposing a transparent mask image on a real object in a display screen of a different display device which a different user wears is included in the virtual object information, the control unit performs control to cause the first-mentioned display device to display an image different from the transparent mask image.

### BACKGROUND

### Field of the Disclosure

Aspects of the present disclosure generally relate to an information processing apparatus, an information processing method, and a storage medium.

Description of the Related Art

Known techniques for merging real world and virtual world in real time include a mixed reality (MR) technique. This technique is a technique which merges a real space and an MR space, which is generated by a computer, in a seamless manner. In MR, using a head-mounted display (HMD) enables having an experience with an MR space with a point of view closer to reality.

A conventional general mixed reality presentation method is a method which only superimposes a computer graphics (CG) image on an image in real video and in which a relationship in depth between a really present object and a CG object is not taken into consideration. Therefore, Japanese Patent Application Laid-Open No. 2003-296759 previously discusses a technique which detects a region in which a real object and a CG object overlap each other and masks a CG image in the detected region to perform displaying in such a way as to make the real object viewable.

The CG image masking method includes, for example, setting an image region deemed to be obtained by image capturing of a real object to a stencil buffer or a depth buffer (Z-buffer) for CG, to obtain the depth of a transparent CG image and prevent a CG image from being drawn at the corresponding portion. This enables acquiring an anteroposterior relationship between a real object and a virtual object.

Moreover, there is a known technique which combines, with a cross reality (XR) device, a technique for sharing three-dimensional models for persons or objects in real time, to enable performing communications with a remotely present user in an MR space in which the same virtual object is shared with different real spaces.

Conceivable method using this technique include, for example, preparing an assembly facility CG image for a prototype factory and checking operations in an MR space with a real object, which is to be actually used after completion of the facilities, held in the user's hand.

Even this case also enables the user holding the real object in the user's hand to obtain a transparent CG mask image in which the anteroposterior relationship between the real object and the virtual object has been reproduced in a pseudo or simulated manner. On the other hand, a remote user which does not hold the real object in the user's hand, by which a masking CG image is shared, is, therefore, caused to view a real space on the remote user side in a transparent manner at a masking CG position where the real object ought to have been drawn. Therefore, in making communications while setting a real object held in the user's hand as a main subject, a situation arises in which the intended content is not able to be communicated.

Moreover, operation modes of the XR device include a case where the XR device operates in virtual reality (VR) and a case where the XR device operates in mixed reality (MR). With regard to data in which masking CG is currently set, in a case where the XR device operates in VR, a situation arises in which, at the masking CG position, a background video image for a virtual space becomes transmissive and thus becomes viewable.

In addition, with regard to data in which masking CG is currently set, due to a place or time in which the user uses the data being different, there are a case where a real object corresponding to masking CG is present and a case where such a real object is not present. If masking CG is directly used in a case where such a real object is not present, a situation arises in which a real space becomes transmissive and thus becomes viewable at a CG masking position where a real object ought to have been drawn.

In a case where a first user sets masking CG to a real object and causes a second user present in a remote location to share such setting, the second user present in a remote location is not able to view the real object and may become able to view a real object appearing as a result of masking CG becoming transparent, so that an obstacle is posed to user experience.

Moreover, depending on an operation mode of the device for displaying XR, a video image appearing as a result of masking CG becoming transparent becomes viewable, so that an obstacle is posed to user experience.

In addition, in a case where the user uses data with masking CG set thereto in different places or at different times, when a real object corresponding to masking CG is not present, a video image appearing as a result of masking CG becoming transparent becomes viewable, so that an obstacle is posed to user experience.

### SUMMARY

Aspects of the present disclosure are generally directed to providing a technique which controls a drawing method for masking CG to provide a more favorable mixed reality (MR) experience to the user.

According to an aspect of the present disclosure, an information processing apparatus for controlling a display operation of a display device which a user wears includes an acquisition unit configured to acquire virtual object information which is information about a virtual object which the information processing apparatus causes the display device to display, and a control unit configured to control displaying of an image of the virtual object based on the virtual object information acquired by the acquisition unit, wherein, in a case where a masking flag which indicates superimposing a transparent mask image on a real object in a display screen of a different display device which a different user wears is included in the virtual object information, the control unit performs control to cause the first-mentioned display device to display an image different from the transparent mask image.

Further features of the present disclosure will become apparent from the following description of exemplary embodiments with reference to the attached drawings.

### BRIEF DESCRIPTION OF THE DRAWINGS

FIGS. 1A, 1B, and 1C are diagrams each illustrating a mixed reality (MR) space obtained by a user superimposing a masking computer graphics (CG) image on a real object.

FIGS. 2A, 2B, and 2C are diagrams each illustrating a positional relationship obtained in a case where a plurality of users shares the MR space.

FIG. 3 is a block diagram illustrating a functional configuration example of a system according to one or more aspects of the present disclosure.

FIG. 4 is a diagram illustrating a configuration example of CG model data concerning one virtual object.

FIG. 5 is a flowchart of masking determination processing according to one or more aspects of the present disclosure.

FIGS. 6A and 6B are diagrams each illustrating a positional relationship between a first user and a second user who are performing operations according to one or more aspects of the present disclosure.

FIGS. 7A, 7B, and 7C are diagram each illustrating a positional relationship between a first user and a second user according to one or more aspects of the present disclosure.

FIG. 8 is a flowchart of masking determination processing according to one or more aspects of the present disclosure.

FIGS. 9A, 9B, 9C, and 9D are diagram each illustrating a positional relationship between a first user and a second user according to one or more aspects of the present disclosure.

FIG. 10 is a block diagram illustrating a functional configuration example of a system according to one or more aspects of the present disclosure.

FIG. 11 is a block diagram illustrating a functional configuration example of a system according to one or more aspects of the present disclosure.

FIG. 12 is a flowchart illustrating a processing procedure which an information processing apparatus performs according to one or more aspects of the present disclosure.

FIGS. 13A, 13B, and 13C are diagrams each illustrating a control example of masking CG according to one or more aspects of the present disclosure.

### DESCRIPTION OF THE EMBODIMENTS

Various exemplary embodiments, features, and aspects of the disclosure will be described in detail below with reference to the drawings. Furthermore, exemplary embodiments to be described below are merely examples of measures for implementing the present disclosure, and can be modified or altered as appropriate according to configurations or various conditions of apparatuses to which the present disclosure is applied. Moreover, some or all of the following exemplary embodiments can be combined as appropriate.

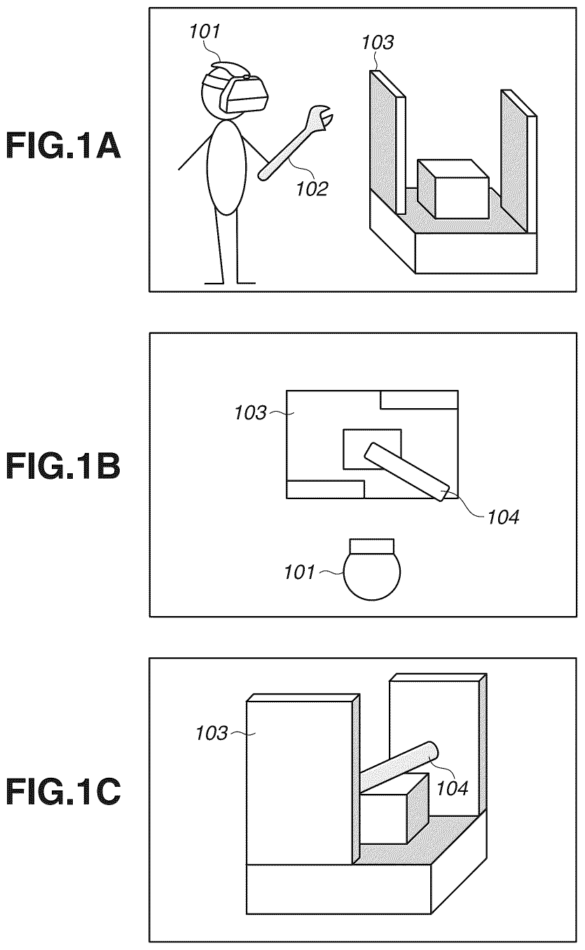

Each of FIGS. 1A, 1B, and 1C illustrates a virtual space obtained by detecting a region in which a real object (also referred to as a “real-world object”) and a computer graphics (CG) object (also referred to as a “virtual object”) overlap each other and masking a CG image in the detected region to display the virtual space in such a way as to make the real object viewable. Furthermore, masking of a CG image is an example of a setting for displaying a real object in front of a virtual object, and can be any method as long as it is a method capable of implementing control to display a real object in front of each of virtual objects or display a real object behind a virtual object.

The superposition technique for superposing masking CG on a real object includes a real object detection unit and a CG masking unit. It is desirable that the real object detection unit correctly displays an overlapping between, for example, a real object 102 which a user 101 is holding in the user's hand and a virtual object 103, such as that illustrated in FIG. 1A. For such occasions, since it only needs to be possible to detect a display area of the real object 102, which the user 101 is holding in the user's hand, in a real video image, the real object detection unit only needs to determine a position and orientation of a real object in a mixed reality (MR) space and detect an area in which an image of the real object is being captured.

FIG. 1B illustrates a positional relationship between the user 101 holding the real object 102 in the user's hand and the virtual object 103 as seen from a higher perspective view of FIG. 1A. FIG. 1C is a diagram illustrating a viewpoint image for the user obtained in a case where the real object, which is in the positional relationship such as that illustrated in FIG. 1B, has been masked.

With regard to a position and orientation detection unit, examples of the virtual viewpoint position and orientation acquisition method include a method of performing image capturing of a marker arranged in a space and estimating a position and orientation of a real viewpoint from the arrangement of feature points of the marker included in the captured image. Additionally, examples of the virtual viewpoint position and orientation acquisition method include a method using simultaneous localization and mapping (SLAM), which simultaneously performs self-position estimation and environmental map creation with use of natural feature points in a real image. Moreover, an external measuring device such as a motion capture system can be used.

With regard to the CG masking unit, for example, the real object detection unit sets an image region in which the real object 102 is deemed to have been image-captured to a stencil buffer for CG or sets the image region to a depth buffer (Z-buffer). With this setting, the real object detection unit acquires the depth of a transparent CG image 104 and prevents a CG image from being drawn at the corresponding portion, thus being able to acquire an anteroposterior relationship between the transparent CG image 104 and the virtual object 103. As a result, as illustrated in FIG. 1C, the real object 102 is viewable in the region of the transparent CG image 104, so that it is possible to obtain a composite image in which the anteroposterior relationship between the real object 102 and the virtual object 103 has been reproduced in a pseudo or simulated manner. Furthermore, a transparent CG image is an example of a transparent mask image.

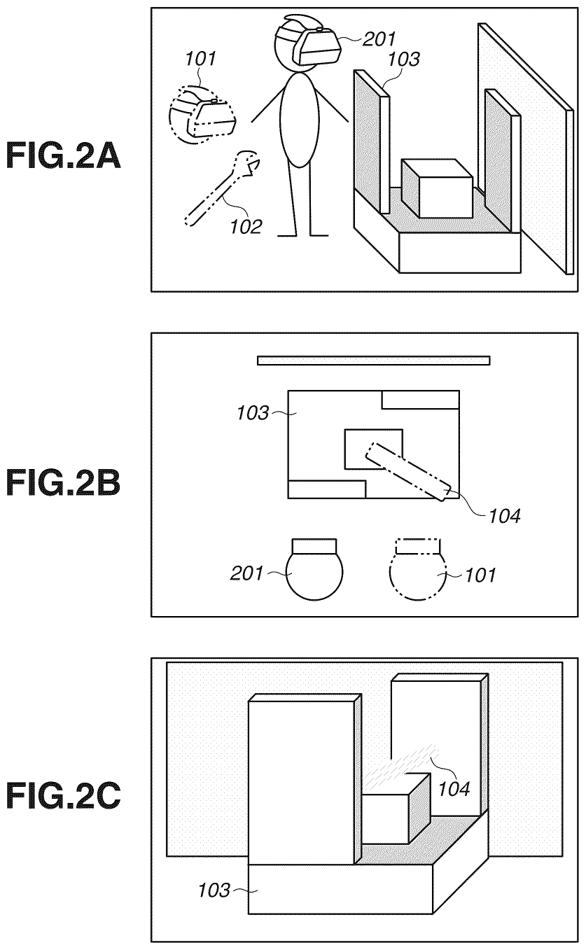

FIGS. 2A, 2B, and 2C are schematic diagrams each illustrating a case where the user 101 and a remotely present user share the same virtual object 103 in the respective real spaces and performs communications in an MR space.

FIG. 2A illustrates a case where the remote user 201, who does not hold the real object 102, and the user 101, which holds the real object 102, share an MR space.

FIG. 2B illustrates a positional relationship between the user 101, the user 201, a masking CG image 104, which is drawn to mask a real object, and the virtual object 103 as seen from a higher perspective view of FIG. 2A. In this case, the user 101 is able to obtain a transparent CG mask image in which the anteroposterior relationship between the real object and the virtual object 103 has been reproduced in a pseudo or simulated manner, such as that illustrated in FIG. 1C.

On the other hand, with regard to the user 201, which does not hold the real object 102, since the masking CG image 104 is shared, a real object is made transmissive and is thus viewable, as illustrated in FIG. 2C. This may bring about a situation in which, in performing communications on the theme of the real object 102 held in the user's hand, the intended content is unable to be transferred. In the following description, exemplary embodiments of the present disclosure are described in detail with reference to the accompanying drawings.

A mixed reality presentation system according to a first exemplary embodiment to be described in the following is a system which presents, to the user, a known mixed reality space (hereinafter referred to as an “MR space”) obtained by merging a real space and a virtual space.

Furthermore, even in the system according to the first exemplary embodiment, in the case of presenting, to the user, an image obtained by merging a real space and an MR space, basically, the system performs drawing in order of an image of the real space and an image of the MR space and performs masking of a region of the virtual object overlapping with the real object as with the above-mentioned conventional example. On the other hand, the system according to the first exemplary embodiment differs from the above-mentioned conventional example in that, when the virtual object the masking of which has been performed is shared, whether a user at the receiving side performs masking is able to set for each user.

In the following description, the mixed reality presentation system according to the first exemplary embodiment is described.

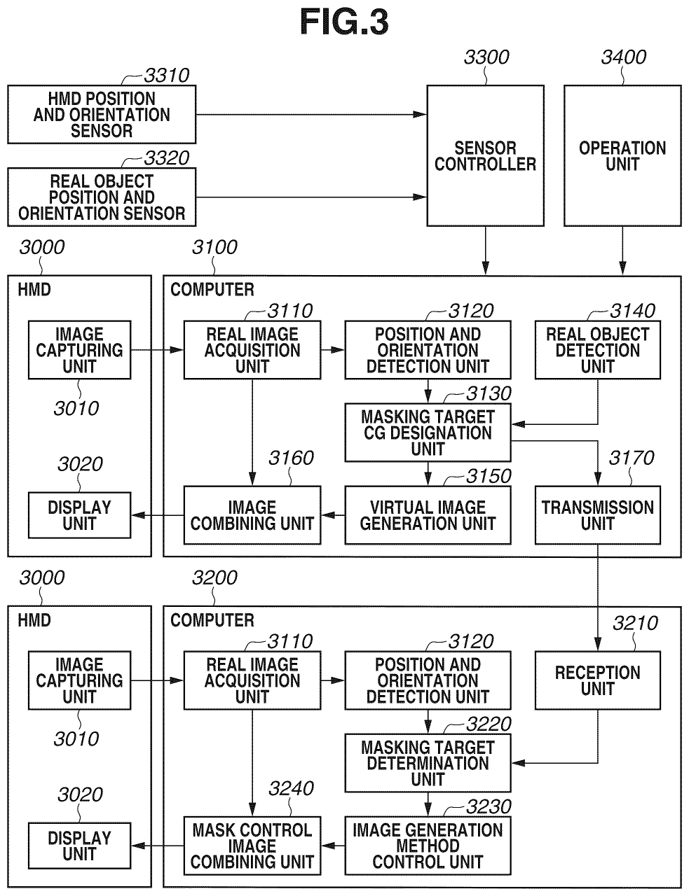

FIG. 3 is a diagram illustrating a basic configuration of the mixed reality presentation system according to the first exemplary embodiment. The mixed reality presentation system is configured with, for example, a computer 3100, a computer 3200, a head-mounted display (HMD) 3000, an HMD position and orientation sensor 3310, a real object position and orientation sensor 3320, a sensor controller 3300, and an operation unit 3400. In the following description, these constituent elements are described. First, the HMD 3000 is described.

The HMD 3000, which is an example of a display device, is a device to be worn on the head of the user who experiences an MR space, and is worn in such a manner that a display unit 3020 (including a display screen) included in the HMD 3000 is located in front of the eyes of the user.

An image capturing unit 3010 is firmly fixed to the HMD 3000 in such a way as to be able to capture a video image in the direction of the line of sight of the user when the user has worn the HMD 3000 on the head. Thus, the image capturing unit 3010 is able to capture a video image of a real space which is viewable depending on the position and orientation of the HMD 3000.

Moreover, the HMD position and orientation sensor 3310 can be firmly fixed to the HMD 3000. The HMD position and orientation sensor 3310 can be configured with, for example, a magnetic sensor or an ultrasonic sensor, and can be configured to measure the position and orientation of the HMD position and orientation sensor 3310 itself and output a result of the measurement as a signal to the sensor controller 3300. In the description of the first exemplary embodiment, the HMD position and orientation sensor 3310 is assumed to measure the position and orientation of the HMD position and orientation sensor 3310 itself in a world coordinate system (a space in which one point in the real space is set as an original point and three axes perpendicular to one another at the original point are set as an x-axis, a y-axis, and a z-axis).

A result of the measurement by the HMD position and orientation sensor 3310 is output as a signal to the sensor controller 3300, and the sensor controller 3300 outputs a numerical value corresponding to the intensity of the received signal to the computer 3100.

The real object position and orientation sensor 3320 is used to change the position and orientation of a virtual object in an MR space when the user who experiences an MR space holds in the user's hand, and can be a sensor configured in the way similar to that of the HMD position and orientation sensor 3310.

Thus, the real object position and orientation sensor 3320 measures the position and orientation of the real object position and orientation sensor 3320 itself in a world coordinate system, and outputs a result of the measurement as a signal to the sensor controller 3300. Similarly, the sensor controller 3300 outputs the result of the measurement as numerical value data corresponding to the intensity of the received signal to the computer 3100. Next, the computer 3100 is described.

Each of the computers 3100 and 3200 is an example of an information processing apparatus, and, generally is configured with, for example, a personal computer (PC) or a workstation (WS). Moreover, each of the computers 3100 and 3200 can be configured with dedicated hardware, or can be configured with a portable terminal such as a smartphone or a tablet terminal. Moreover, each of the computers 3100 and 3200 can be configured to be separate from the HMD 3000, or can be mounted in the HMD 3000.

The operation unit 3400 is able to input various instructions to the computer 3100. The operation unit 3400 can be configured with one or a plurality of units for button inputs, gesture inputs, and voice inputs received from a controller device or a button-type device such as a keyboard.

The image capturing unit 3010 captures a moving image of a real space which is viewable depending on the position and orientation of the HMD 3000, and images for respective frames constituting the captured moving image (real space images) are sequentially input to the computer 3100. Accordingly, a real image acquisition unit 3110 acquires a real space image from the image capturing unit 3010.

For the purpose of obtaining the position and orientation of the image capturing unit 3010 in a world coordinate system, a position and orientation detection unit 3120 acquires a position and orientation measured by the HMD position and orientation sensor 3310 and converted into numerical value data by the sensor controller 3300. Then, the position and orientation detection unit 3120 can obtain the position and orientation of the image capturing unit 3010 in a world coordinate system from a result obtained by the HMD position and orientation sensor 3310. On this occasion, the position and orientation detection unit 3120 can perform known conversion processing with use of a position and orientation relationship between the image capturing unit 3010 and the HMD position and orientation sensor 3310. Furthermore, the position and orientation relationship between the image capturing unit 3010 and the HMD position and orientation sensor 3310 is assumed to be preliminarily measured.

Moreover, the position and orientation detection unit 3120 acquires a result measured by the real object position and orientation sensor 3320 and converted into numerical value data by the sensor controller 3300.

A real object detection unit 3140 performs processing for detecting a specific real object, for example, a region which the real object 102 illustrated in FIG. 1A is occupying, from a real image which the image capturing unit 3010 has acquired.

For example, the region which the real object 102 is occupying is obtained by detecting a pixel group including a region which a real object is occupying from specific position and orientation information in a real space image. The real object detection unit 3140 acquires an image formed by the detected pixel group (an image in a region which a specific real object is occupying in a real space image).

Moreover, the detection of a specific real object can be performed by detecting a pixel group representing a given specific color in a real image or pixel group having a specific shape.

In addition, the real object detection unit 3140 can detect a new real object from a real image which the image capturing unit 3010 has acquired and register the detected new real object with virtual object information. Moreover, the real object detection unit 3140 can detect color information or information about, for example, glossiness, haze, image clarity (distinctness of image), or diffuseness, which is detailed information about a real object, and register the detected information with virtual object information, or can add the detected information to the registered virtual object information or update the virtual object information with the detected information. Additionally, the real object detection unit 3140 can calculate, from the detected information about the real object, the position and orientation of the real object.

A masking target CG designation unit 3130 refers to virtual object model data used for rendering a virtual object constituting an MR space and selects data about a virtual object to be set as a masking target. The virtual object model data is the one provided for every virtual object. For example, the virtual object model data can be stored in a storage unit (not illustrated) of the computer 3100 or 3200, or can be stored by another database server. For example, the masking target CG designation unit 3130 can specify a virtual object corresponding to a real object with use of, for example, a marker included in an image, or can specify a virtual object corresponding to a real object based on, for example, shape or color information about the real object. Moreover, the user can manually specify the virtual object.

Next, masking processing which the masking target CG designation unit 3130 performs is described.

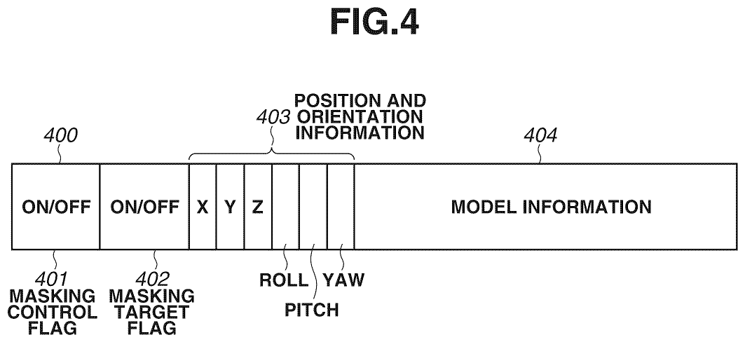

FIG. 4 is a diagram illustrating a configuration example of CG model data concerning one virtual object. Virtual object information about a virtual object (CG object), which is to be drawn in the first exemplary embodiment (in the following description, also referred to as “configuration information 400 about a virtual object”), includes position and orientation information 403 indicating the position and orientation (the position (x, y, z) and orientation (roll, pitch, yaw) of the virtual object. Additionally, the virtual object information further includes, in addition to model information 404, which is visual information such as the color or shape of a virtual object, a masking target flag 402, which is used to indicate whether the virtual object is currently set as a target for masking, and a masking control flag 401.

The masking target flag 402 can be expressed with one bit indicating ON or OFF (ON/OFF). For example, the case where the value of the masking target flag 402 is “1” (ON) indicates that the virtual object “is a target for masking”. Moreover, the case where the value of the masking target flag 402 is “0” (OFF) indicates that the virtual object “is not a target for masking”. In other words, the case where the value of the masking target flag 402 included in virtual object information is “1” indicates that a masking flag for superimposing a transparent mask image on a real object is included in the virtual object information. Furthermore, the masking target flag 402 is an example of masking flag information.

With regard to the masking target flag 402, ON/OFF (presence/absence) thereof can be determined, for example, by the user of the computer 3100 preliminarily performing setting with use of the operation unit 3400. Moreover, with regard to, for example, an operation panel needed to be always presented to the user (a virtual object serving as a graphical user interface (GUI)), the masking target flag 402 can be determined in such a way as to be dynamically changed to always keep the masking target flag OFF.

Even in that case, the actual flag value setting processing is performed by the masking target CG designation unit 3130.

As with the masking target flag 402, the masking control flag 401 can be expressed with one bit indicating ON or OFF (ON/OFF). For example, the case where the value of the masking control flag 401 is “1” (ON) indicates that “the received masking target flag has been changed from ON to OFF”. Moreover, the case where the value of the masking control flag 401 is “0” (OFF) indicates that “there is no change in the received masking target flag”. Furthermore, the masking control flag 401 is an example of display control information.

The masking control flag 401 is a flag which is used for processing which the computer 3200 described below performs, and is not used for processing which the computer 3100 performs.

The masking target CG designation unit 3130 refers to the value of the masking target flag 402 included in CG model data about each virtual object and designates, as a drawing target, only CG model data (model image) the value of the masking target flag 402 of which is OFF. Then, a virtual image generation unit 3150 generates (renders) an image of a virtual object serving as a virtual drawing target according to the model information 404 in the CG model data.

Furthermore, in performing this rendering, the virtual image generation unit 3150 generates an image of a virtual object which is viewable from the image capturing unit 3010, with use of line-of-sight, position, and orientation information and position and orientation information in the CG model data.

Moreover, in the case of rendering a virtual object the position and orientation of which dynamically changes (for example, a virtual object located at the position of the real object position and orientation sensor 3320), the virtual image generation unit 3150 updates the position and orientation information of the virtual object as appropriate before performing the above-mentioned rendering processing. Then, the virtual image generation unit 3150 generates an image of a virtual object which is viewable from the image capturing unit 3010, with use of the updated position and orientation information and the line-of-sight, position, and orientation information.

The technique of rendering a virtual object image which is viewable from a predetermined line-of-sight, position, and orientation is a known technique and is, therefore, omitted from description here.

An image combining unit 3160 superimposes a virtual image which the virtual image generation unit 3150 has generated on a real space image which the real image acquisition unit 3110 has acquired. With this processing, at a portion which is being masked in a composite image, a virtual object the value of the masking target flag 402 of which is ON is masked and a real image is drawn. In an image the value of the masking target flag 402 of which is OFF, a virtual object which is not being masked is drawn.

Next, the computer 3200 is described. The same constituent elements as those of the computer 3100 are assigned the respective same reference numerals and are, therefore, omitted from description here.

A transmission unit 3170 of the computer 3100 inputs data about a virtual object to a masking target determination unit 3220 via a reception unit 3210 of the computer 3200. Furthermore, the reception unit 3210 is an example of an acquisition unit. Here, masking determination processing which the masking target determination unit 3220 performs is described.

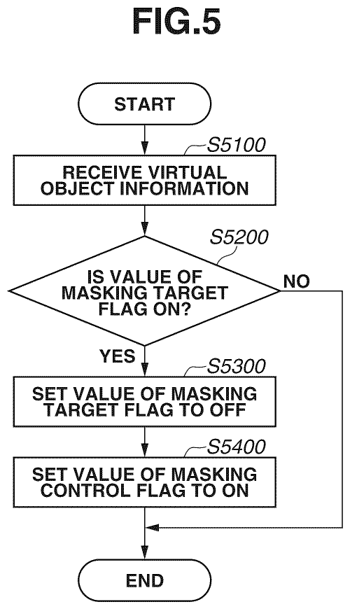

FIG. 5 is a flowchart illustrating masking determination processing concerning one virtual object. First, in step S5100, the masking target determination unit 3220 acquires configuration information 400 about a virtual object.

In step S5200, the masking target determination unit 3220 determines whether the value of the masking target flag 402, which indicates whether the virtual object is currently set as a target for masking, is ON. If it is determined that the value of the masking target flag 402 is ON (YES in step S5200), the masking target determination unit 3220 advances the processing to step S5300. If it is determined that the value of the masking target flag 402 is OFF (NO in step S5200), the masking target determination unit 3220 inputs the configuration information 400 about the virtual object to an image generation method control unit 3230.

In step S5300, the masking target determination unit 3220 sets the value of the masking target flag 402 to OFF, and then advances the processing to step S5400.

In step S5400, the masking target determination unit 3220 sets the value of the masking control flag 401 to ON, and then inputs the configuration information 400 about the virtual object to the image generation method control unit 3230.

The image generation method control unit 3230 refers to the value of the masking control flag 401 and the value of the masking target flag 402 included in CG model data about each virtual object and thus generates an image.

Thus, since the case where the value of the masking control flag 401 is ON indicates that the value of the masking target flag 402 of the received virtual object has been changed from ON to OFF, the image generation method control unit 3230 sets CG model data about this virtual object as a drawing target. With regard to the drawing method, for example, the image generation method control unit 3230 can designate a single color or a plurality of colors which has been previously set by the user of the computer 3200 via the operation unit 3400. For example, with regard to the drawing method, the image generation method control unit 3230 can append a color designated by the user to a transparent mask image. Moreover, the image generation method control unit 3230 can preliminarily prepare a virtual object similar to or identical with a virtual object indicated by the previously received virtual object information and, in a case where the value of the masking control flag 401 is ON, the image generation method control unit 3230 can set the prepared virtual object as a drawing target. Moreover, the image generation method control unit 3230 can perform drawing with use of color information or information about, for example, glossiness, haze, image clarity (distinctness of image), or diffuseness of the real object, which the image generation method control unit 3230 has acquired from the real object detection unit 3140 and has then retained. Thus, the image generation method control unit 3230 can perform drawing which looks like a real object even in a virtual space, and, for example, the image generation method control unit 3230 can digitize a real object into a texture image and then apply the texture image to the shape of a virtual object.

With regard to CG model data the value of the masking target flag 402 of which is OFF, the image generation method control unit 3230 can generate an image of a virtual object serving as a drawing target according to the model information 404 in the CG model data. Then, with regard to CG model data the value of the masking control flag 401 of which is ON, the image generation method control unit 3230 generates an image of a virtual object according to the drawing method and the model information 404 in the CG model data.

Furthermore, in performing this rendering, the image generation method control unit 3230 generates an image of a virtual object which is viewable from the image capturing unit 3010, with use of the line-of-sight, position, and orientation information and the position and orientation information in the CG model data.

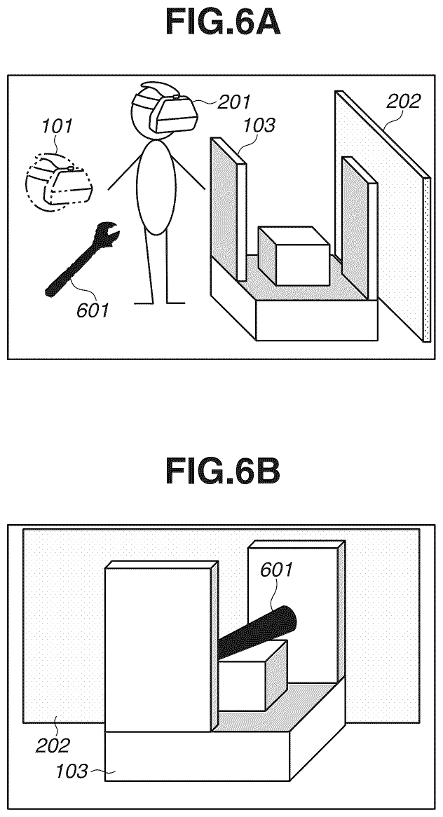

A mask control image combining unit 3240 superimposes a virtual image which the image generation method control unit 3230 has generated on a real space image which the real image acquisition unit 3110 has acquired. Specifically, the mask control image combining unit 3240 is an example of an acquisition unit, and, in a case where the value of the masking target flag 402 is OFF (i.e., in a case where the value of the masking control flag 401 is ON), the mask control image combining unit 3240 causes the HMD 3000 to display an image different from the transparent CG image 104. With this processing, at a portion which the computer 3200 is masking in a real space image, an image of a virtual object the value of the masking target flag 402 of which is ON is not drawn, but, in an image the value of the masking target flag 402 of which is OFF, a virtual object is drawn. FIGS. 6A and 6B are schematic diagrams illustrating operations which are performed in the first exemplary embodiment.

FIG. 6A illustrates an MR space for a remote user 201 who does not hold a real object in a case where operations in the first exemplary embodiment are performed.

While a virtual object 601 serving as a masking target of the real object 102 which the user 101 holds is shared by the user 201, the virtual object 601 is visualized and displayed as a visible image by the masking target determination unit 3220 and the image generation method control unit 3230.

FIG. 6B illustrates a viewpoint image for the user 201. The user 201 is able to obtain a CG image in which an anteroposterior relationship of the virtual object 103 has been reproduced in a pseudo or simulated manner, at the position of the real object 102 which the user 101 holds.

As described above, according to the first exemplary embodiment, in the case of having received masking CG, controlling a drawing method for masking CG enables providing a favorable MR experience.

### Modification Example 1 of First Exemplary Embodiment

In the first exemplary embodiment, there is a conceivable case where, when displaying is performed with a drawing method for masking CG being controlled and is used by a plurality of persons, the user moves the position of a virtual object for which the drawing method for masking CG has been controlled. In that case, the user who is performing displaying of a virtual object while controlling the drawing method for masking CG is able to obtain favorable displaying. On the other hand, for a user who holds a real object and is displaying the real object using masking CG, since the place of masking CG moves, displaying of the real object may be hindered. Therefore, a virtual object which is displayed with a drawing method for masking CG being controlled can be controlled in such a manner that the position and orientation of the virtual object is not allowed to be changed. Moreover, in a case where the user performs an operation to move a virtual object which is being displayed with a drawing method for masking CG being controlled, instead of moving the virtual object which is being displayed with a drawing method for masking CG being controlled, the same virtual object can be duplicated and displayed at the position which the user has performed the operation. Then, performing setting such that the duplicated virtual object is shared by a plurality of persons enables performing movement of even a virtual object which is being displayed with a drawing method for masking CG being controlled.

### Modification Example 2 of First Exemplary Embodiment

While, in the description of the first exemplary embodiment, in the case of having received masking CG, a drawing method for masking CG is controlled, there is a case where, depending on a situation of the user who has received masking CG, the value of the masking control flag 401 does not necessarily need to be updated.

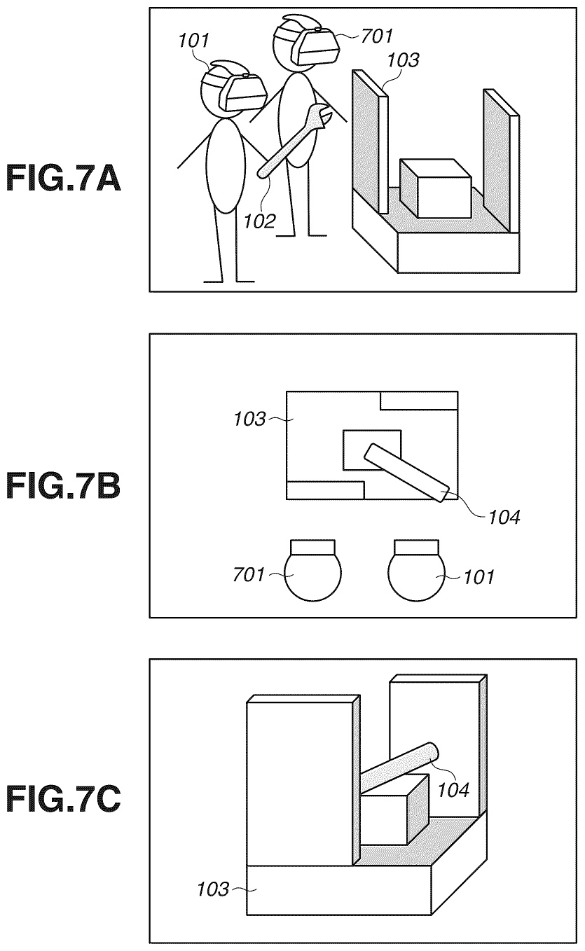

FIGS. 7A, 7B, and 7C are diagrams illustrating a case where a user 101 who holds the real object 102 and a user 701 who does not hold the real object 102 share an MR space in the same place.

FIG. 7B illustrates a positional relationship between the user 101, the user 701, a masking CG image 104, which is drawn to mask a real object, and a virtual object 103 as seen from a higher perspective view of FIG. 7A. In this case, the user 101 is able to obtain a masking image in which an anteroposterior relationship between the real object 102 and the virtual object 103 has been reproduced in a pseudo or simulated manner, such as that illustrated in FIG. 7C. On the other hand, while the masking CG image 104 is shared by the user 701 which does not hold the real object 102, at this time, the real object 102 which the user 101 holds in the user's hand is viewable by the user 701. Therefore, it is not necessary to control masking with use of the masking control flag 401 to perform image generation control, and a masking image can be drawn as with that for the user 101 as illustrated in FIG. 7C. Here, masking determination processing which the masking target determination unit 3220 performs in the present modification example is described.

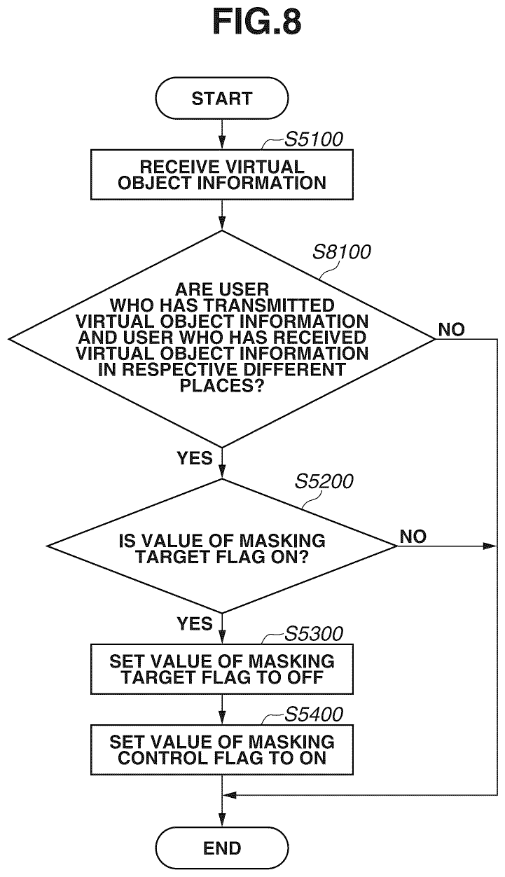

FIG. 8 is a flowchart illustrating masking determination processing concerning one virtual object in the present modification example.

The same processing operations as those in the first exemplary embodiment are assigned the respective same step numbers and are, therefore, omitted from description here.

In step S5100, the masking target determination unit 3220 acquires configuration information 400 about a virtual object.

In step S8100, the masking target determination unit 3220 determines whether a user who has transmitted the configuration information 400 about a virtual object and a user who has received the transmitted configuration information 400 are in the respective different places. If it is determined that the users are connecting to the system at the respective different places (YES in step S8100), the masking target determination unit 3220 advances the processing to step S5200. If it is determined that the users are connecting to the system at the same place (NO in step S8100), the masking target determination unit 3220 inputs the configuration information 400 about a virtual object to the image generation method control unit 3230.

The determination as to whether the user who has transmitted the configuration information 400 about a virtual object and the user who has received the transmitted configuration information 400 are in the same place can be performed by, for example, determining whether the users are acquiring position and orientation information from the same sensor controller. Moreover, the determination as to whether the user who has transmitted the configuration information 400 about a virtual object and the user who has received the transmitted configuration information 400 are in the same place can be performed by determining whether the users are calculating position and orientation information based on the same point in a world coordinate system. Moreover, such a determination can be performed by determining whether the users have previously acquired, from the sensor controller, position and orientation information about a real object serving as a masking target. Moreover, such a determination can be performed based on viewpoint images for the respective users, such as by determining whether an HMD for the user who has transmitted the configuration information 400 about a virtual object is included in the viewpoint images for the users or by determining whether a real object serving as a masking target is included in the viewpoint images for the users. Moreover, the user can operate the operation unit 3400 to preliminarily set users who share a transparent CG image, or preliminarily set location information or Global Positioning System (GPS) information can be used for such a determination.

As described above, even in a case where it is not necessary to control masking in such a way as to perform connection in the same place, it is possible to flexibly generate an MR image depending on the situation of an MR space.

While, in the above-described first exemplary embodiment, pieces of configuration information about all of the virtual objects, including a virtual object which the masking target CG designation unit 3130 has designated as a masking target, are shared by users, there is a case where it is not always necessary to share all of the virtual objects. In that case, a configuration in which a virtual object to be shared is switched according to the user's intention can be employed.

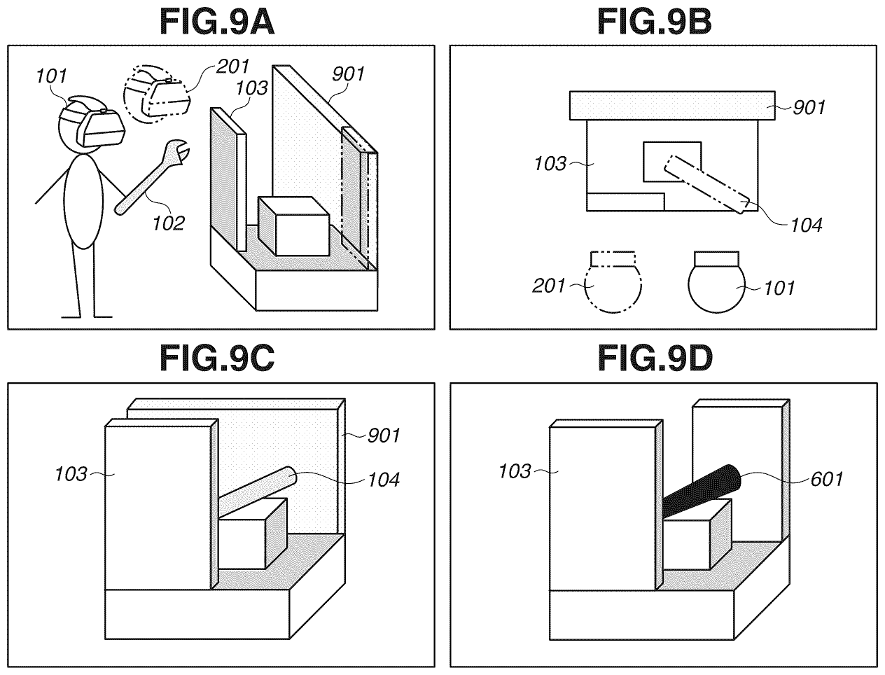

For example, FIGS. 9A, 9B, 9C, and 9D are diagrams illustrating a case where a user 101 who holds the real object 102 and a remote user 201 who does not hold the real object 102 share an MR space in the same place. There is a case where, in an environment of the user 101 who holds the real object 102, a real stationary object 901 (for example, a shelf) is present. In this case, in consideration of a safety during MR space experience of the user 101, the real stationary object 901 is designated as a masking target in such a manner that the real stationary object 901 does not become invisible due to the presence of the virtual object 103.

FIG. 9B illustrates a positional relationship between the user 101, the user 201, a masking CG image 104, which is drawn to mask a real object, a virtual object 103, and the real stationary object 901 present in the environment of the user 101 as seen from a higher perspective view of FIG. 9A.

In a virtual experience provided at this time, the real stationary object 901 is not a main theme of the virtual experience and just only needs to be viewable by the user 101, so that a virtual object superimposed on the real stationary object 901 does not need to be shared by the user 201.

In this case, the user 101 is able to obtain an image in which the anteroposterior relationship between the real object 102 and the virtual object 103 has been reproduced in a pseudo or simulated manner and on which the real object 102 held in the user's hand and the real stationary object 901 have been superimposed, such as that illustrated in FIG. 9C. On the other hand, the user 201, who does not hold the real object 102, does not need to share a virtual object in which the real stationary object 901 has been masked and only needs to be able to obtain an image such as that illustrated in FIG. 9D.

Here, a mixed reality presentation system in a second exemplary embodiment which implements the above-described operations is described.

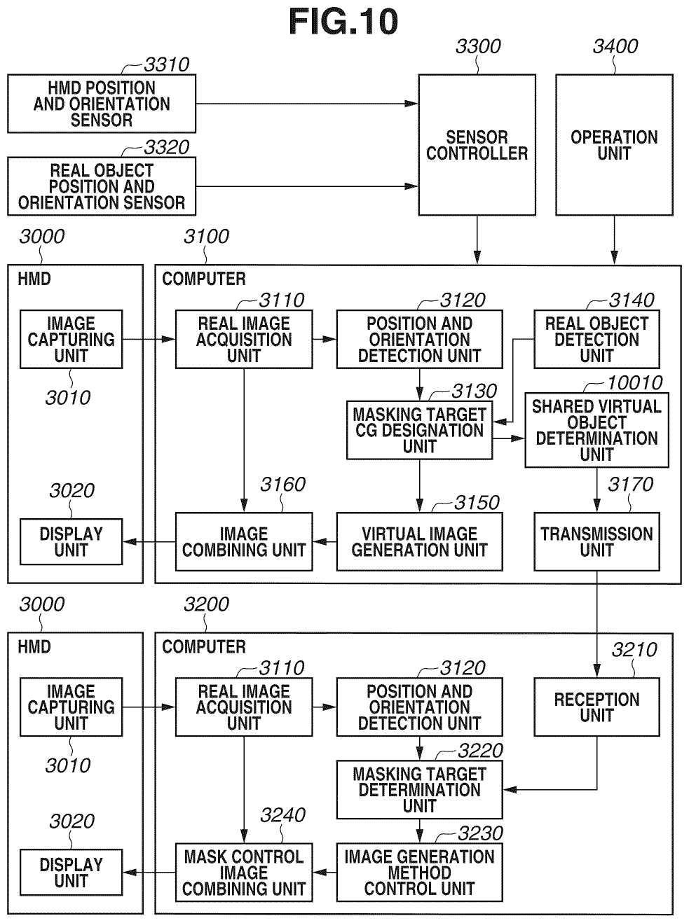

FIG. 10 is a diagram illustrating a basic configuration of the mixed reality presentation system according to the second exemplary embodiment.

The same constituent elements as those in the first exemplary embodiment are assigned the respective same reference numerals and are, therefore, omitted from description here.

A shared virtual object determination unit 10010 obtains virtual object data about every virtual object from the masking target CG designation unit 3130. From among pieces of virtual object data, the shared virtual object determination unit 10010 determines a virtual object to be shared by another user via the transmission unit 3170.

The determination of a virtual object to be shared can be performed, for example, by the user preliminarily setting a virtual object to be shared with use of the operation unit 3400, or can be performed with use of the amount of movement of position and orientation of a real object per a certain time. Moreover, the determination of a virtual object to be shared can be performed by determining whether the position of a virtual object serving as a masking target and the position of another virtual object are away from each other by a threshold value or more.

The transmission unit 3170 transmits, to another user for sharing, only configuration information 400 about a virtual object which has been determined to be shared with another user by the shared virtual object determination unit 10010.

As described above, it is possible to cause a virtual object the masking information about which does not need to be shared not to be shared, so that it is possible to flexibly generate a composite image depending on the situation of an MR space.

While, in the above-described second exemplary embodiment, control of a masking target to be performed in a case where a virtual space is shared by a plurality of persons has been described, the present disclosure is not limited to the case where a virtual space is shared by a plurality of persons.

Thus, when the user is experiencing a virtual space alone, the user can dynamically change masking ON/OFF of a masking CG image designated as a masking target. Specifically, the user can dynamically change such masking ON/OFF depending on whether a video image to be displayed to the user is a virtual reality space (VR space) or a mixed reality space (MR space). Additionally, in the case of using virtual object information in which a masking flag which the information processing apparatus is holding is included, due to a place or time which the user uses being different, there are a case where a real object corresponding to the virtual object information in which the masking flag is included is present and a case where such a real object is not present. In such cases, the user can dynamically change the masking flag.

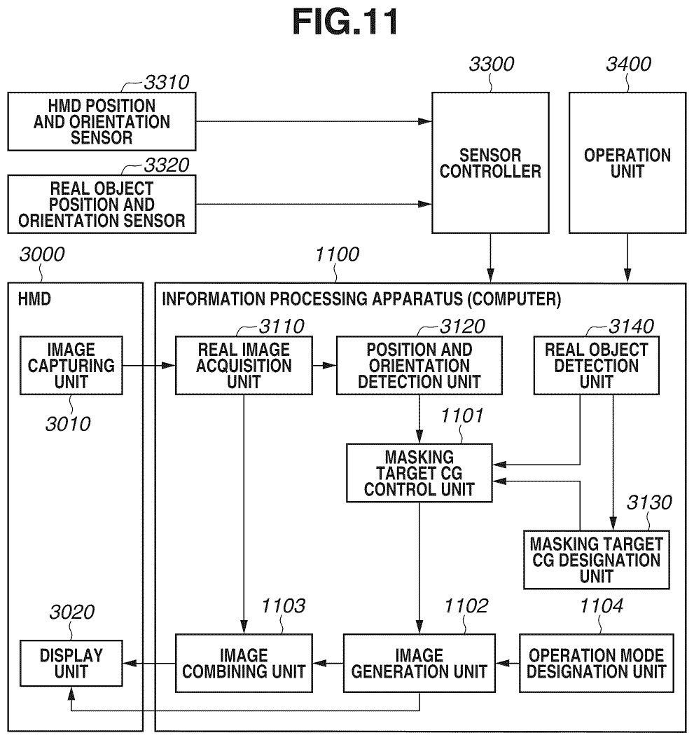

FIG. 11 is a diagram illustrating a configuration example of a system according to a third exemplary embodiment. FIG. 11 illustrates an image processing system for presenting, to a system experiencer (user), a virtual reality space (VR space) or a mixed reality space (MR space), in which a real space and a virtual space are merged. The same portions as those illustrated in FIG. 3 are assigned the respective same reference numerals and are, therefore, omitted from description here.

A masking target CG control unit 1101 sets, to a virtual object the value of the masking target flag is ON, ON or OFF of a masking control flag playing the role of controlling the presence or absence of masking.

An image generation unit 1102 builds a virtual space corresponding to the setting of a masking control flag which the masking target CG control unit 1101 has set. Data about the virtual space includes pieces of data concerning the respective virtual objects constituting the virtual space and data concerning a light source which illuminates the inside of the virtual space. Then, the image generation unit 1102 sets the position and orientation of a virtual viewpoint corresponding to the position and orientation of an HMD which the position and orientation detection unit 3120 has acquired. Then, the image generation unit 1102 generates an image of a virtual space which is viewable from such a virtual viewpoint (virtual space image). Then, in a case where the display device operates to display an MR image, the image generation unit 1102 advances the processing to an image combining unit 1103, and, in a case where the display device operates to display a virtual space image, the image generation unit 1102 outputs the generated virtual space image to the display unit 3020. Furthermore, the technique for generating an image of a virtual space which is viewable from a viewpoint having a predetermined position and orientation is a known technique, and, therefore, the detailed description thereof is omitted.

The image combining unit 1103 generates an MR image by combining a virtual space image generated by the image generation unit 1102 and a real space image captured by the image capturing unit 3010. Then, the image combining unit 1103 outputs the generated MR image to the display unit 3020.

An operation mode designation unit 1104 designates which of a VR space and an MR space a video image to be displayed on the HMD 3000, which is a display device, is. With regard to the method for designating an operation mode, for example, the operation mode designation unit 1104 performs an inquiry about operation modes which the HMD (display device) 3000 is able to set, and then designates an operation mode based on information received as a response from the HMD (display device) 3000. In the case of a display device capable of performing both displaying of a VR space and displaying of an MR space, the operation mode designation unit 1104 can designate an operation mode according to the user's designation.

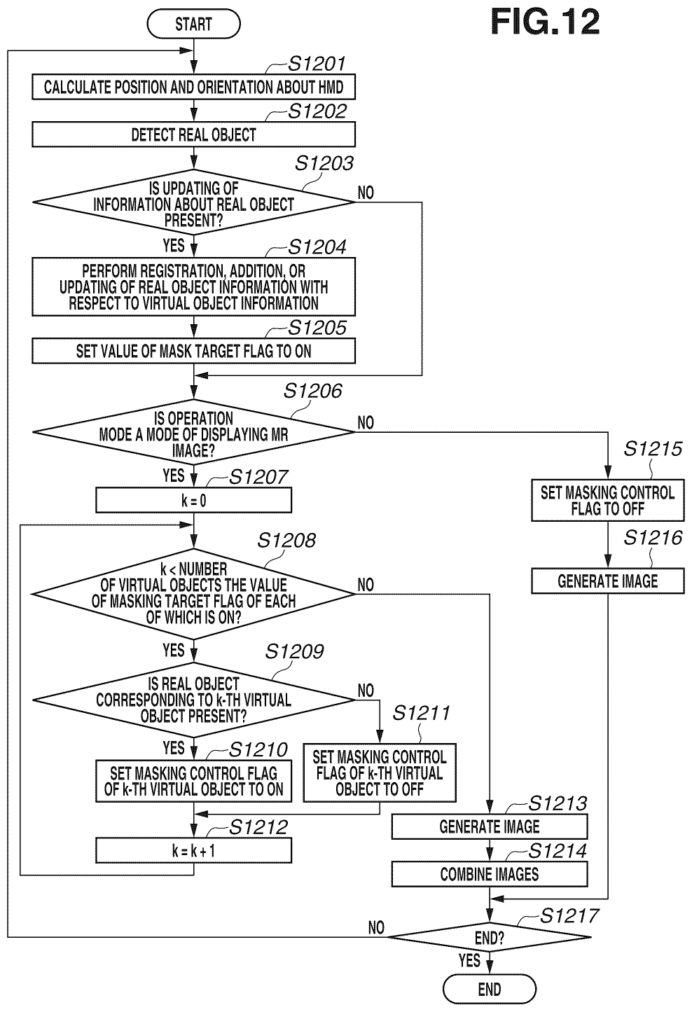

FIG. 12 is a flowchart of processing which an information processing apparatus (computer) 1100 according to the third exemplary embodiment performs to generate a VR video image or an MR video image and output the generated video image to the HMD 3000.

First, in step S1201, the position and orientation detection unit 3120 calculates respective pieces of position and orientation information about the HMD 3000 and a real object.

Next, in step S1202, the real object detection unit 3140 detects a real object present in a real space.

Next, in step S1203, the real object detection unit 3140 determines the presence or absence of updating of information about a real object present in a real space. If it is determined that updating of information about the real object is present (YES in step S1203), the real object detection unit 3140 advances the processing to step S1204, and, if it is determined that updating of information about the real object is absent (NO in step S1203), the real object detection unit 3140 advances the processing to step S1206.

Next, in step S1204, the real object detection unit 3140 performs registration, addition, or updating of the information about the real object with respect to the virtual object information.

Next, in step S1205, the masking target CG designation unit 3130 sets the value of the masking target flag to ON concerning the virtual object information with respect to which registration, addition, or updating of the information about the real object has been performed.

Next, in step S1206, the operation mode designation unit 1104 determines whether the operation mode is a mode of displaying an MR image. If it is determined that the operation mode is a mode of displaying an MR image (YES in step S1206), the operation mode designation unit 1104 advances the processing to step S1207, and, if it is determined that the operation mode is not a mode of displaying an MR image, i.e., the operation mode is a mode of displaying a VR image (NO in step S1206), the operation mode designation unit 1104 advances the processing to step S1215.

Next, in step S1207, the masking target CG control unit 1101 sets “k=1” as initial setting. Then, in step S1208, the masking target CG control unit 1101 compares the value of k with the number of virtual objects the value of the masking target flag of each of which is ON. If it is determined that the value of k is less than the number of virtual objects the value of the masking target flag of each of which is ON (YES in step S1208), the masking target CG control unit 1101 advances the processing to step S1209, and, if it is determined that the value of k is greater than or equal to the number of virtual objects the value of the masking target flag of each of which is ON (NO in step S1208), the masking target CG control unit 1101 advances the processing to step S1213.

Next, in step S1209, the masking target CG control unit 1101 determines whether a real object corresponding to the k-th virtual object the value of the masking target flag of which is ON is present. If it is determined that a real object corresponding to the k-th virtual object the value of the masking target flag of which is ON is present (YES in step S1209), the masking target CG control unit 1101 advances the processing to step S1210, and, if it is determined that a real object corresponding to the k-th virtual object the value of the masking target flag of which is ON is not present (NO in step S1209), the masking target CG control unit 1101 advances the processing to step S1211.

Next, in step S1210, the masking target CG control unit 1101 sets, to ON, a masking control flag of the k-th virtual object the value of the masking target flag of which is ON.

Next, in step S1211, the masking target CG control unit 1101 sets, to OFF, a masking control flag of the k-th virtual object the value of the masking target flag of which is ON.

Next, in step S1212, the masking target CG control unit 1101 increases the numerical value of k by 1. Then, the masking target CG control unit 1101 returns the processing to step S1208.

In step S1213, the image generation unit 1102 generates an image of a virtual space with use of position and orientation information about the virtual viewpoint calculated in step S1201.

Next, in step S1214, the image combining unit 1103 combines a real image captured by the image capturing unit 3010 and the virtual space image generated in step S1213.

Next, in step S1215, the masking target CG control unit 1101 sets, to OFF, a masking control flag of the virtual object the value of the masking target flag of which is ON.

Next, in step S1216, the image generation unit 1102 generates an image of a virtual space with use of position and orientation information about the virtual viewpoint calculated in step S1201.

Next, in a case where an end instruction for the present processing has been input or a condition for ending the present processing has been satisfied, the information processing apparatus (computer) 1100 ends the present processing. On the other hand, in a case where neither an end instruction for the present processing has been input nor a condition for ending the present processing has been satisfied, the information processing apparatus (computer) 1100 returns the processing to step S1201 via step S1217.

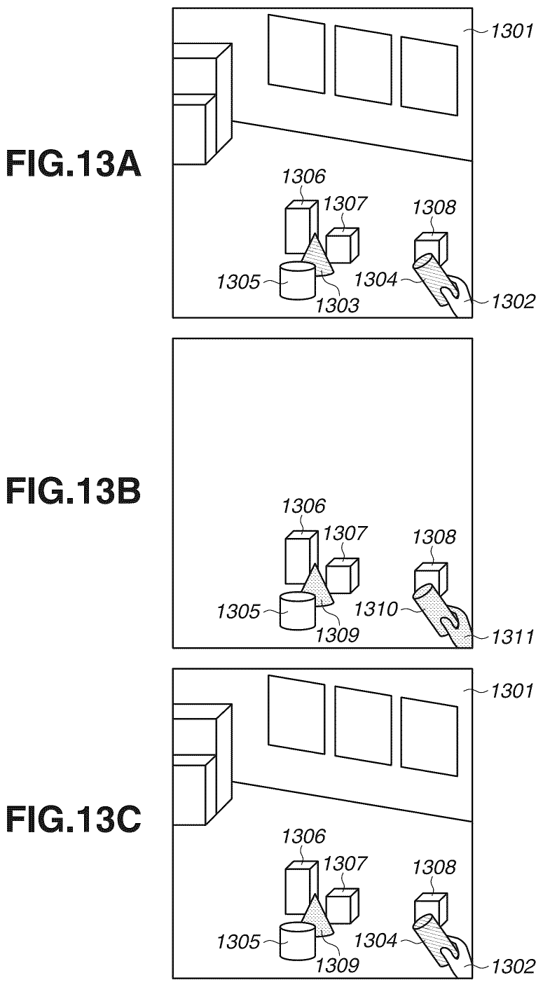

FIGS. 13A, 13B, and 13C illustrate images representing results of image combining and image generation performed by the image combining unit 1103 and the image generation unit 1102. Thus, FIGS. 13A, 13B, and 13C are diagrams illustrating operations in which controlling masking target CG enables displaying a favorable MR image or VR image depending on the operation mode of a display device or the presence or absence of a real object.

An image 1301 represents a real space, which has been captured by the image capturing unit 3010.

A user's hand 1302 is present in the real space. Real objects 1303 and 1304 are present in the real space, and masking target CG images (not illustrated) are arranged at the respective same places as those of the real objects 1303 and 1304. Virtual objects 1305, 1306, 1307, and 1308 are displayed. Then, virtual objects 1309 and 1310 obtained by controlling masking target CG are displayed, and a virtual object 1311 by controlling masking target CG with respect to the user's hand is displayed.

FIG. 13A is a diagram illustrating a result of image combining which the image combining unit 1103 has generated. Arranging the masking target CG images (not illustrated) at the respective same places as those of the real objects 1303 and 1304 enables the image combining unit 1103 to generate an MR image which has correctly represented a depth relationship.

FIG. 13B is a diagram illustrating a result of image generation which the image generation unit 1102 has generated when the operation mode is VR image displaying. Virtual objects 1309, 1310, and 1311 are displayed by controlling masking target CG. With this control operation, with regard to a depth relationship between real objects and virtual objects which are displayed as illustrated in FIG. 13A, even in a case where the operation mode is VR image displaying, a VR image which has correctly expressed a depth relationship using virtual objects is generated.

FIG. 13C is a diagram illustrating a result of image combining which the image combining unit 1103 has generated from the same data as that illustrated in FIG. 13A in a case where the real object 1303 has disappeared from the state illustrated in FIG. 13A.

Since the real object 1303 is not present, the virtual object 1309 is displayed by controlling masking target CG. With this control operation, with respect to data in which masking target CG has been set, even in a case where a real object is not present, a usage similar to that for the time when the real object is present becomes available.

### Modification Examples

While, in the description of each of the above-described exemplary embodiments, the display device is an HMD, the display device is not limited to an HMD and can be a hand-held display (HHD). The HHD is a display to be held in one or both hands. Thus, the HMD which the user uses can be the above-mentioned ordinary monitor. Additionally, the HMD which the user uses can be a display which the user holds in the user' hand and looks into to observe an image as with binoculars. Additionally, the display device can be a display terminal such as a tablet, a smartphone, or an ordinary monitor. Moreover, a display device which connects to the information processing apparatus can be switched to another display device, or, when a plurality of display devices is connected to the information processing apparatus, a display device to which the information processing apparatus performs outputting can be switched between the plurality of display devices.

### Supplement

Furthermore, the present disclosure can also be implemented by performing the following processing. Thus, the processing includes supplying software (program) for implementing the functions of the above-described exemplary embodiments to a system or apparatus via a network or any type of storage medium and causing a computer (or, for example, a control unit or a micro processing unit (MPU)) of the system or apparatus to read out and execute program code of the software. In this case, the program and a storage medium storing the program constitute the present disclosure.

While the present disclosure has been described above based on the exemplary embodiments thereof, the present disclosure is not limited to such specific exemplary embodiments, but also includes various embodiments within a range not departing from the gist of the present disclosure. Some or all of the above-described exemplary embodiments can be combined as appropriate.

Furthermore, the respective functional units of the above-described exemplary embodiments (modification examples) can be individual pieces of hardware or can be other than those. The functions of two or more functional units can be implemented by shared hardware. Each of a plurality of functions of one functional unit can be implemented by an individual piece of hardware. Two or functions of one functional unit can be implemented by shard hardware. Moreover, each functional unit can be implemented by hardware such as an application specific integrated circuit (ASIC), a field-programmable gate array (FPGA), or a digital signal processor (DSP) or can be implemented by other than that. For example, the apparatus can include a processor and a memory (storage medium) storing a control program. Then, the functions of at least some of functional units included in the apparatus can be implemented by the processor reading out the control program from the memory and executing the control program.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the functions of the above-described exemplary embodiments can also be implemented by a circuit which implements one or more functions of the above-described exemplary embodiments (for example, an application specific integrated circuit (ASIC)). Furthermore, disclosures in the above-described exemplary embodiments include the following configurations.

### Configuration 1

An information processing apparatus for controlling a display operation of a display device which a user wears, the information processing apparatus including:
an acquisition unit configured to acquire virtual object information which is information about a virtual object which the information processing apparatus causes the display device to display; and
a control unit configured to control displaying of an image of the virtual object based on the virtual object information acquired by the acquisition unit,
wherein, in a case where a masking flag which indicates superimposing a transparent mask image on a real object in a display screen of a different display device which a different user wears is included in the virtual object information, the control unit performs control to cause the first-mentioned display device to display an image different from the transparent mask image.

### Configuration 2

The information processing apparatus as set forth in Configuration 1, wherein the transparent mask image is a transparent image that is based on model information included in the virtual object information.

### Configuration 3

The information processing apparatus as set forth in Configuration 1 or 2, wherein, in a case where the masking flag is not included in the virtual object information acquired by the acquisition unit, the control unit performs control to cause the first-mentioned display device to display a visible image that is based on model information included in the virtual object information.

### Configuration 4

The information processing apparatus as set forth in any one of Configurations 1 to 3, wherein the image different from the transparent mask image is an image obtained by appending a color to the transparent mask image.

### Configuration 5

The information processing apparatus as set forth in Configuration 4, wherein the color to be appended to the transparent mask image is a preliminarily designated color.

### Configuration 6

The information processing apparatus as set forth in Configuration 3 or 4, wherein the color to be appended to the transparent mask image is a color that is based on color information about the real object acquired by the different display device.

### Configuration 7

The information processing apparatus as set forth in Configuration 1, wherein the image different from the transparent mask image is a model image that is based on the transparent mask image.

### Configuration 8

The information processing apparatus as set forth in any one of Configurations 1 to 7, wherein, in a case where the first-mentioned display device and the different display device are present in an identical space, the control unit performs control to superimpose the transparent mask image on the real object irrespective of whether the masking flag is included in the virtual object information.

### Configuration 9

The information processing apparatus as set forth in Configuration 8, wherein whether the first-mentioned display device and the different display device are present in an identical space is determined based on whether respective pieces of position and orientation information about the first-mentioned display device and the different display device are being acquired from an identical sensor controller.

### Configuration 10

The information processing apparatus as set forth in any one of Configurations 1 to 9, wherein the information processing apparatus is mounted on the first-mentioned display device.

### Configuration 11

A control method for controlling a display operation of a display device which a user wears, the control method including:
acquiring virtual object information which is information about a virtual object which the information processing apparatus causes the display device to display; and
controlling displaying of an image of the virtual object based on the acquired virtual object information,
wherein, in a case where a masking flag which indicates superimposing a transparent mask image on a real object in a display screen of a different display device which a different user wears is included in the virtual object information, the controlling displaying of an image of the virtual object includes performing control to cause the first-mentioned display device to display an image different from the transparent mask image.

### Configuration 12

A non-transitory computer-readable storage medium storing a program for causing a computer to perform a control method for controlling a display operation of a display device which a user wears, the control method including:
acquiring virtual object information which is information about a virtual object which the information processing apparatus causes the display device to display; and
controlling displaying of an image of the virtual object based on the acquired virtual object information,
wherein, in a case where a masking flag which indicates superimposing a transparent mask image on a real object in a display screen of a different display device which a different user wears is included in the virtual object information, the controlling displaying of an image of the virtual object includes performing control to cause the first-mentioned display device to display an image different from the transparent mask image.

### Configuration 13

An information processing apparatus for controlling a display operation of a display device which a user wears, the information processing apparatus including:
an acquisition unit configured to acquire an image obtained by the display device;
a determination unit configured to, based on virtual object information about a virtual object corresponding to a real object included in the image, determine whether to superimpose a transparent mask image on the real object in a display screen of the display device; and
a transmission unit configured to transmit the virtual object information to a different information processing apparatus.

### Configuration 14

The information processing apparatus as set forth in Configuration 13, wherein the different information processing apparatus is an apparatus which controls a display operation of a different display device which a different user wears.

### Configuration 15

The information processing apparatus as set forth in Configuration 14, wherein the virtual object information includes masking flag information indicating whether to superimpose a transparent mask image on a real object in a display screen of the first-mentioned display device, and display control information for controlling displaying of the virtual object in a display screen of the different display device.

### Configuration 16

The information processing apparatus as set forth in Configuration 15, wherein the display control information is set based on the masking flag information.

### Configuration 17

The information processing apparatus as set forth in Configuration 16, wherein, in a case where the masking flag information indicates superimposing a transparent mask image on a real object in a display screen of the first-mentioned display device, the display control information indicates generating an image different from the transparent mask image in a display screen of the different display device.

### Configuration 18

The information processing apparatus as set forth in any one of Configurations 13 to 17, wherein the transmission unit does not transmit, to the different display device, the virtual object information about the virtual object on which a setting indicating not performing sharing with the different information processing apparatus has been performed.

### Configuration 19

An information processing apparatus for controlling a display operation of a display device which a user wears, the information processing apparatus including:
an acquisition unit configured to acquire virtual object information which is information about a virtual object which the information processing apparatus causes the display device to display; and
a control unit configured to control displaying of an image of the virtual object based on the virtual object information acquired by the acquisition unit,
wherein, in a case where a masking flag which indicates superimposing a mask image on a real object is included in the virtual object information, the control unit controls displaying of the mask image based on an acquisition environment of the virtual object information.

### Configuration 20

The information processing apparatus as set forth in Configuration 19, wherein the acquisition environment of the virtual object information is based on an operation mode of the display device.

### Configuration 21

The information processing apparatus as set forth in Configuration 20, wherein the operation mode of the display device includes a mode for displaying a mixed reality (MR) image.

### Configuration 22

The information processing apparatus as set forth in any one of Configurations 19 to 21, wherein the acquisition environment of the virtual object information is an environment including one of an environment in which the real object is present and an environment in which the real object is not present.

### Configuration 23

The information processing apparatus as set forth in any one of Configurations 19 to 22, further including a real object acquisition unit configured to acquire information about the real object,
wherein the control unit appends a setting for displaying the real object in front of the virtual object, based on the information about the real object and the virtual object information.

### Configuration 24

The information processing apparatus as set forth in Configuration 23, wherein the information about the real object includes at least one or more of shape information, color information, glossiness, haze, image clarity, and diffuseness.

### Configuration 25

The information processing apparatus as set forth in Configuration 23 or 24, wherein the real object acquisition unit updates the virtual object information including the masking flag based on the appended setting.

### Configuration 26

The information processing apparatus as set forth in any one of Configurations 19 to 25, wherein the acquisition environment of the virtual object information is based on a place in which each of a plurality of users is.

According to aspects of the present disclosure, it is possible to provide a technique which controls a drawing method for masking CG to provide a more favorable mixed reality (MR) experience to the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-055833 filed Mar. 29, 2024 and Japanese Patent Application No. 2024-223121 filed Dec. 18, 2024, which are hereby incorporated by reference herein in their entirety.

What is claimed is:

1. An information processing apparatus for controlling a display operation of a display device which a user wears, the information processing apparatus comprising:
an acquisition unit configured to acquire virtual object information which is information about a virtual object which the information processing apparatus causes the display device to display; and
a control unit configured to control displaying of an image of the virtual object based on the virtual object information acquired by the acquisition unit,
wherein, in a case where a masking flag which indicates superimposing a transparent mask image on a real object in a display screen of a different display device which a different user wears is included in the virtual object information, the control unit performs control to cause the first-mentioned display device to display an image different from the transparent mask image.

2. The information processing apparatus according to claim 1, wherein the transparent mask image is a transparent image that is based on model information included in the virtual object information.

3. The information processing apparatus according to claim 2, wherein, in a case where the masking flag is not included in the virtual object information acquired by the acquisition unit, the control unit performs control to cause the first-mentioned display device to display a visible image that is based on model information included in the virtual object information.

4. The information processing apparatus according to claim 1, wherein the image different from the transparent mask image is an image obtained by appending a color to the transparent mask image.

5. The information processing apparatus according to claim 4, wherein the color to be appended to the transparent mask image is a preliminarily designated color.

6. The information processing apparatus according to claim 4, wherein the color to be appended to the transparent mask image is a color that is based on color information about the real object acquired by the different display device.

7. The information processing apparatus according to claim 1, wherein the image different from the transparent mask image is a model image that is based on the transparent mask image.

8. The information processing apparatus according to claim 1, wherein, in a case where the first-mentioned display device and the different display device are present in an identical space, the control unit performs control to superimpose the transparent mask image on the real object irrespective of whether the masking flag is included in the virtual object information.

9. The information processing apparatus according to claim 8, wherein whether the first-mentioned display device and the different display device are present in an identical space is determined based on whether respective pieces of position and orientation information about the first-mentioned display device and the different display device are being acquired from an identical sensor controller.

10. The information processing apparatus according to claim 1, wherein the information processing apparatus is mounted on the first-mentioned display device.

11. A control method for controlling a display operation of a display device which a user wears, the control method comprising:
acquiring virtual object information which is information about a virtual object which the information processing apparatus causes the display device to display; and
controlling displaying of an image of the virtual object based on the acquired virtual object information,
wherein, in a case where a masking flag which indicates superimposing a transparent mask image on a real object in a display screen of a different display device which a different user wears is included in the virtual object information, the controlling displaying of an image of the virtual object includes performing control to cause the first-mentioned display device to display an image different from the transparent mask image.

12. A non-transitory computer-readable storage medium storing a program for causing a computer to perform a control method for controlling a display operation of a display device which a user wears, the control method comprising:
acquiring virtual object information which is information about a virtual object which the information processing apparatus causes the display device to display; and
controlling displaying of an image of the virtual object based on the acquired virtual object information,
wherein, in a case where a masking flag which indicates superimposing a transparent mask image on a real object in a display screen of a different display device which a different user wears is included in the virtual object information, the controlling displaying of an image of the virtual object includes performing control to cause the first-mentioned display device to display an image different from the transparent mask image.

13. An information processing apparatus for controlling a display operation of a display device which a user wears, the information processing apparatus comprising:
an acquisition unit configured to acquire an image obtained by the display device;
a determination unit configured to, based on virtual object information about a virtual object corresponding to a real object included in the image, determine whether to superimpose a transparent mask image on the real object in a display screen of the display device; and
a transmission unit configured to transmit the virtual object information to a different information processing apparatus.

14. The information processing apparatus according to claim 13, wherein the different information processing apparatus is an apparatus which controls a display operation of a different display device which a different user wears.

15. The information processing apparatus according to claim 14, wherein the virtual object information includes masking flag information indicating whether to superimpose a transparent mask image on a real object in a display screen of the first-mentioned display device, and display control information for controlling displaying of the virtual object in a display screen of the different display device.

16. The information processing apparatus according to claim 15, wherein the display control information is set based on the masking flag information.

17. The information processing apparatus according to claim 16, wherein, in a case where the masking flag information indicates superimposing a transparent mask image on a real object in a display screen of the first-mentioned display device, the display control information indicates generating an image different from the transparent mask image in a display screen of the different display device.

18. The information processing apparatus according to claim 13, wherein the transmission unit does not transmit, to the different display device, the virtual object information about the virtual object on which a setting indicating not performing sharing with the different information processing apparatus has been performed.

19. An information processing apparatus for controlling a display operation of a display device which a user wears, the information processing apparatus comprising:
an acquisition unit configured to acquire virtual object information which is information about a virtual object which the information processing apparatus causes the display device to display; and
a control unit configured to control displaying of an image of the virtual object based on the virtual object information acquired by the acquisition unit,
wherein, in a case where a masking flag which indicates superimposing a mask image on a real object is included in the virtual object information, the control unit controls displaying of the mask image based on an acquisition environment of the virtual object information.

20. The information processing apparatus according to claim 19, wherein the acquisition environment of the virtual object information is based on an operation mode of the display device.

21. The information processing apparatus according to claim 20, wherein the operation mode of the display device includes a mode for displaying a mixed reality (MR) image.

22. The information processing apparatus according to claim 19, wherein the acquisition environment of the virtual object information is an environment including one of an environment in which the real object is present and an environment in which the real object is not present.

23. The information processing apparatus according to claim 19, further comprising a real object acquisition unit configured to acquire information about the real object,
wherein the control unit appends a setting for displaying the real object in front of the virtual object, based on the information about the real object and the virtual object information.

24. The information processing apparatus according to claim 23, wherein the information about the real object includes at least one or more of shape information, color information, glossiness, haze, image clarity, and diffuseness.

25. The information processing apparatus according to claim 23, wherein the real object acquisition unit updates the virtual object information including the masking flag based on the appended setting.

26. The information processing apparatus according to claim 19, wherein the acquisition environment of the virtual object information is based on a place in which each of a plurality of users is.
